(19) United States
(12) Patent Application Publication
(10) Pub. No.: US 2025/0390888 A1
(43) Pub. Date: Dec. 25, 2025

(54) SYSTEMS AND METHODS FOR MANAGING RECALL REQUESTS IN A FACILITY

(71) Applicant: Honeywell International Inc., Charlotte, NC (US)

(72) Inventors: Ankit Singh, Apex, NC (US); Varun Singh, PUNE (IN); Lakshminarayana Paila, Frisco, TX (US)

(21) Appl. No.: 18/752,827

(22) Filed: Jun. 25, 2024

(51) Int. Cl. G06Q 30/014

(52) U.S. Cl. CPC G06Q 30/014

(57) ABSTRACT

Various embodiments described herein relate to systems and methods for managing recall requests in a facility. In this regard, first objects associated with one or more fields of a recall request is initially received in the facility. At least one first object of the first objects is parsed through a model. Also, second objects associated with the one or more fields of the recall request is then retrieved from a database. Based on the parsing, a first mapping for the first objects with the second objects are determined. Based at least on some algorithms and factors, a second mapping for the first objects with the second objects are also determined. A mapping for each of the first objects with the corresponding second objects is identified using the first and the second mappings. The mapping for each of the first objects is rendered via user interface using visual representations.

### TECHNICAL FIELD

The present disclosure generally relates to recall management in facilities. More particularly, the present disclosure relates to managing one or more recall requests associated with products of the facilities.

### BACKGROUND

Generally, facilities related to life sciences domain such as pharmaceuticals, biotechnology, medicines, medical devices, biomedical technologies, and/or the like often encounter product recalls. Such facilities usually initiate recalls to withdraw certain products from distribution and/or to implement corrective actions in regard to products for which defects are reported. However, the facilities may receive innumerable recall requests across several product lines. Additionally, product recall is not a simple process at all, and it involves several workflows in itself. For example, the product recall process involves workflows/phases such as a global partition phase, an investigation phase to check if the recall request is legit along with other inquiries and followed by an execution phase to execute the recall process. But for efficient and effective management of recall requests, it is vital to track statuses and analyze factors associated with each of the workflows of the recall process. For instance, it becomes necessary to track and analyze factors such as number of recalls, geographical regions associated with recall requests, impact of recall requests, business impact due to recall requests, and/or the like. However, there can be several recall requests for a same product from different geographical regions across the globe at different point of time. Also, the recall requests placed might vary from customer-to-customer in view of content though context associated with the recall requests is same. This makes recall management even more complicated and challenging in the facilities.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary recall management system, in accordance with one or more example embodiments described herein.

FIG. 4 illustrates a flowchart showing a method described in accordance with one or more example embodiments described herein.

FIG. 5 illustrates a flowchart showing a method described in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for managing one or more recall requests in a facility is described herein. In this regard, the method comprises receiving one or more first objects from a user associated with the facility. Per this aspect, the one or more first objects are associated with one or more fields of a recall request. Further, the method comprises parsing at least one first object of the one or more first objects through a model. Furthermore, the method comprises retrieving from a database, one or more second objects associated with the one or more fields of the recall request. Then, the method comprises determining a first mapping for the one or more first objects with the one or more second objects based on the parsing of the at least one first object. Also, the method comprises determining a second mapping for the one or more first objects with the one or more second objects based at least on one or more algorithms and one or more factors. Using the first mapping and the second mapping, the method comprises identifying a mapping for each of the one or more first objects with the corresponding one or more second objects. The method also comprises rendering, via a user interface, the mapping for each of the one or more first objects using one or more visual representations.

In accordance with another embodiment of the current disclosure, a system for managing one or more recall requests in a facility is described herein. The system comprises a processor and a memory communicatively coupled to the processor, wherein the memory comprises one or more instructions which when executed by the processor, cause the processor to receive one or more first objects from a user associated with the facility. Per this aspect, the one or more first objects are associated with one or more fields of a recall request. The processor is also configured to parse at least one first object of the one or more first objects through a model. Further, the processor is configured to retrieve from a database, one or more second objects associated with the one or more fields of the recall request. Then, the processor is configured to determine a first mapping for the one or more first objects with the one or more second objects based on the parsing of the at least one first object. Also, the processor is configured to determine a second mapping for the one or more first objects with the one or more second objects based at least on one or more algorithms and one or more factors. Using the first mapping and the second mapping, the processor is configured to identify a mapping for each of the one or more first objects with the corresponding one or more second objects. Furthermore, the processor is also configured to render, via a user interface, the mapping for each of the one or more first objects using one or more visual representations.

In accordance with yet another embodiment of the current disclosure, a non-transitory, computer-readable storage medium having instructions stored thereon and executable by one or more processors is described herein. In this regard, the instructions when executed by one or more processors cause the one or more processors to receive one or more first objects from a user associated with the facility. Per this aspect, the one or more first objects are associated with one or more fields of a recall request. The one or more processors are also configured to parse at least one first object of the one or more first objects through a model. Further, the one or more processors are also configured to retrieve from a database, one or more second objects associated with the one or more fields of the recall request. Then, the one or more processors are configured to determine a first mapping for the one or more first objects with the one or more second objects based on the parsing of the at least one first object. Also, the one or more processors are configured to determine a second mapping for the one or more first objects with the one or more second objects based at least on one or more algorithms and one or more factors. Using the first mapping and the second mapping, the one or more processors are configured to identify a mapping for each of the one or more first objects with the corresponding one or more second objects. Furthermore, the one or more processors are also configured to render, via a user interface, the mapping for each of the one or more first objects using one or more visual representations.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases "in an embodiment," "in one embodiment," "according to one embodiment," and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word "exemplary" is used herein to mean "serving as an example, instance, or illustration." Any implementation described herein as "exemplary" is not necessarily to be construed as preferred or advantageous over other implementations. If the specification states a component or feature "can," "may," "could," "should," "would," "preferably," "possibly," "typically," "optionally," "for example," "often," or "might" (or other such language) be included or have a characteristic, that particular component or feature is not required to be included or to have the characteristic. Such component or feature can be optionally included in some example embodiments, or it can be excluded.

In general, the facilities have a standard framework with respect to the recall management. In this regard, the facilities may have certain set of rules or policies to deal with different phases of the recall process. Additionally, the facilities may also have a set of templates to address the recall requests internally within the facilities upon receipt of the requests from customers. Per this aspect, the set of templates may have standard terminologies to address the recall requests internally. For example, the set of templates may have different main fields such as complaints, deviations, non-conformance, internal audit, and/or the like. Further, the main fields may have sub-fields such as product number, batch ID, severity measure, business risk, supplier status, closure rate, and/or the like. Provided that several customers spread across different geographical regions submit the recall requests, there may be variations in content or choice of words used in the recall requests. In this regard, the recall requests submitted by the customers may or may not have the same terminologies as in the set of templates followed internally. Manually analyzing such recall requests by skilled operators is cumbersome and error prone in view of volume of incoming requests and variations in the recall requests. For instance, the operators may be unaware of all possible terminologies in the set of templates for a specific choice of word used by a customer in a recall request. So the operator may wrongly analyze a context associated with the recall request and wrongly map the request to incorrect domain or focal. This often leads to unoptimized usage of human resources and under-utilization of computing resources in the facilities for addressing the requests. Accordingly, recall management becomes challenging and inefficient in facilities.

Thus, to address the above challenges, various examples of systems and methods described herein facilitate management of recall requests associated with products in a facility. The facility may be related to life sciences domain such as pharmaceuticals, biotechnology, medicines, medical devices, biomedical technologies, and/or the like. The systems and methods proposed herein describe determination of mappings between enterprise objects submitted by customers as part of recall requests and template objects that are stored in repository/database of the facility. The mappings created between the appropriate objects facilitate efficient processing of recall requests even if fields or content provided by the customers in the recall requests is subjected to variations. For example, a customer may submit a recall request associated with packing of a product and this may include “classification” as an object i.e., enterprise object here. So, the customer may fill “classification” in one of a field of the recall request. But the template objects stored in repository/database of the facility may not have “classification” as a template object for recall requests associated with packing of products. However, a template object with “severity” may exist in the database which actually means “classification” referred by the customer. Said alternatively, the object “classification” referred by the customer means same as the object “severity” stored in the database for internal reference. An operator may be unaware of such mappings. In view of such variations in content of the recall requests, the systems and methods described herein provide smart mapping techniques for users to accurately map content in the recall requests with internally followed templates in the facility. In this regard, the systems and methods described herein facilitate efficient processing and management of recall requests in the facility.

For instance, the system embodiment described herein is initially configured to receive one or more first objects from a user associated with the facility. The user may correspond to one or more customers associated with the facility. While in some scenarios, the user may also correspond to personnel such as admins, managers, and/or operators in the facility. The aforementioned one or more first objects are associated with one or more fields of a recall request. At times, when the user is submitting the recall request, the user is often expected to fill out a form as per operating procedures of the facility. In this regard, the user may be expected to fill details in one or more fields of the recall request. For example, if the recall request is associated with packaging issue of a product, then the user may indicate the same issue in one field. Further, in another field, the user may provide detailed explanation of the issue i.e., a brief of problems faced by the user in view of defects in packaging. Yet in another field, the user may provide feedback or suggestions to improve the packaging quality of the product. The details provided by the user correspond to the one or more first objects. Then, such recall requests are processed internally within the facility to make sure that appropriate actions are taken in a timely manner. The facilities may also store such first objects in the database based on the processing of the recall requests for further usage as well.

Also, to deal with the recall requests, the facility may also have a set of templates that are followed internally. Per this aspect, the set of templates may have template objects i.e., internally followed standard terminologies to address the recall requests. In this regard, the standard terminologies may be stored as one or more second objects in the database. At times, the first objects provided by the customers may not be same as the internally followed standard terminologies or the second objects. Accordingly, the system provides smart mapping techniques to map the first objects and the second objects. In this regard, the facility may employ several artificial intelligence (AI) and/or machine learning (ML) based algorithms, models, etc., as a part of the smart mapping techniques. For example, the facility may incorporate techniques such as fuzzy name matching algorithm, large language models (LLMs), data validation, and/or the like. Initially, the system parses at least some of the one or more first objects associated with the recall request through a model. The model used by the system herein may correspond to large language models (LLMs). The LLMs using at least some of the one or more first objects determine a context associated with the one or more first objects. Then, the system retrieves one or more second objects from the database such that the one or more second objects are also associated with the one or more fields of the recall request. The context determined then facilitates a first mapping of the one or more first objects with the one or more second objects. Further, the system utilizes one or more algorithms to perform a second mapping between the one or more first objects with the one or more second objects. The one or more algorithms may be fuzzy name matching algorithm, algorithms for grammar-based synonym matching, data validation, and/or the like. Also, the system performs the second mapping based on one or more factors as well. In this regard, the one or more factors correspond to a phase of the recall process, historical mappings for similar requests, historical execution of the recall process, and/or the like.

Based on the first mapping and the second mapping, the system then determines a final mapping for each of the one or more first objects with the corresponding one or more second objects. In this regard, the system makes sure that mapping of the one or more first objects with the one or more second objects is accurate so that the further dealing of the recall requests is hassle free in the facility. Also, the system makes sure to render via a user interface, the mapping for each of the one or more first objects using one or more visual representations. The one or more visual representations correspond to visually highlighting a first object and a corresponding second object to which the first object is to be mapped, showing a link such as an arrow or dotted lines between a first object and a corresponding second object, highlighting a first object with a color and providing same highlight color to top second objects that map onto the first object, and/or the like. Thus, the systems and methods described herein eliminate the errors and time-consuming process where skilled operators need to manually match the customer submitted objects with the template objects. Also, the systems and methods make sure that the objects are mapped based on numerous factors such as a phase of the recall process, historical records, and/or the like to make sure that the first objects are appropriately mapped onto the relevant second objects. With this, the recall requests submitted to the facility can be efficiently processed so that the requests are directed to right domain and right focal for addressing the requests. On an overall, this saves time and computing resources along with increased productivity of resources and recall processes in the facility.

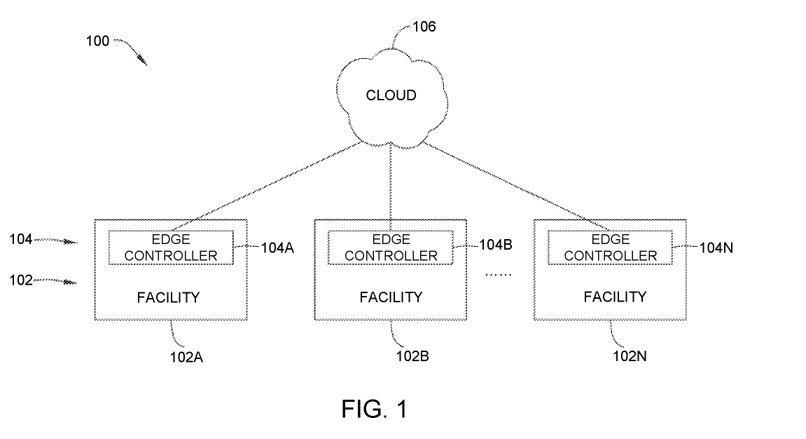

FIG. 1 illustrates a schematic diagram showing an exemplary environment comprising multiple facilities. According to various example embodiments described herein, an exemplary environment 100 comprises one or more facilities 102a, 102b,....102n (collectively “facilities 102”). In some example embodiments, a facility of the one or more facilities 102a, 102b,....102n may be related to life sciences domain such as pharmaceuticals, biotechnology, medicines, medical devices, biomedical technologies, and/or the like. In some example embodiments, the one or more facilities 102a, 102b,....102n in the illustrative environment 100 may be of same type. In some example embodiments, the one or more facilities 102a, 102b,....102n in the illustrative environment 100 may be of different type. As it may be understood, in some example embodiments described herein, a facility of the one or more facilities 102a, 102b,....102n often employs several workers and processes to produce one or more products. At times, the facility may be required to recall certain products from distribution and/or to implement corrective actions in regard to products for which defects are reported. Per this aspect, the facility also receives one or more recall requests for the one or more products. It is to be noted that the one or more recall requests are received from different customers spread across different locations. For example, when a user such as a customer is submitting a recall request, the user is often expected to fill out a form as per operating procedures of the facility and at times the user fills the form in their own choice of words. Generally, in the customer submitted recall requests, the customers mostly define one or more fields of the request using their own choice of words. Accordingly, the recall requests may be subjected to variations in view of content in the recall requests. To further address the one or more recall requests, it becomes essential that the one or more recall requests are processed appropriately in the facility.

In some example embodiments, a cloud 106 is operably coupled with one or more facilities 102a, 102b,....102n, meaning that communication between the cloud 106 and one or more facilities 102a, 102b,....102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services for recall management in the facilities 102. Per this aspect, the one or more services of the cloud 106 appropriately handle, process, and/or manage the data at the cloud 106 to generate appropriate mappings for customer submitted recall requests with internally followed templates in the facility. Also, the cloud 106 may include or generate models required to handle, process, and/or manage the data in order to facilitate management of the one or more recall requests in a respective facility. In some example embodiments, the cloud 106 includes one or more servers that may be programmed to communicate with the one or more facilities 102a, 102b,....102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Further, in one or more example embodiments, each of the facilities 102 may have a set of standard operating procedures for recall process. The recall process may involve several workflows/phases such as a global partition phase, an investigation phase to check if a recall request is legit along with other inquiries and followed by an execution phase to execute the recall process. Considering all of such phases, the facility often creates one or more forms with one or more pre-defined fields associated with the recall requests. Also, the facility may incorporate a set of templates that are to be followed internally to address the recall requests. While submitting a recall request, a user such as a customer is often expected to fill such forms. For example, if the recall request is associated with packaging issue of a product, then the user may indicate the same issue in one field. Further, in another field, the user may provide detailed explanation of the issue i.e., a brief of problems faced by the user in view of defects in packaging. Yet in another field, the user may provide feedback or suggestions to improve the packaging quality of the product. Often, content in such recall requests is subjected to variations as the user may define the one or more fields in their own choice of words. In the example shown in FIG. 1, each of the one or more facilities 102a, 102b,....102n includes a respective edge controller (alternatively, edge gateway) 104a, 104b,....104n (collectively “edge controllers 104” or “edge gateways 104”). In some example embodiments, each of one or more edge controllers 104a, 104b,....104n is configured to receive the data from the respective facilities 102. In some examples, the one or more edge controllers 104a, 104b,....104n may operate as intermediary node to transact the data between the facilities 102 and/or the cloud 106. In this regard, the data includes one or more recall requests and/or one or more templates in the facilities 102. Additionally, the data also includes metadata and/or other relevant data associated with the facilities 102. In some examples, each of the one or more edge controllers 104a, 104b,....104n is capable of receiving the data from disparate data sources e.g., but not limited to, in different data formats and/or using various data communication protocols, from the facilities 102. In this regard, each of the one or more edge controllers 104a, 104b,....104n can receive & filter the data and translate the data into a common language and/or format (e.g. normalized data) for subsequent communication to the cloud 106. The common language and/or format may be compatible with and expected by the cloud 106.

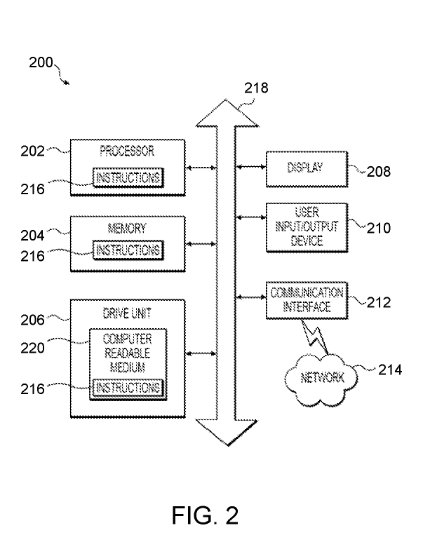

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

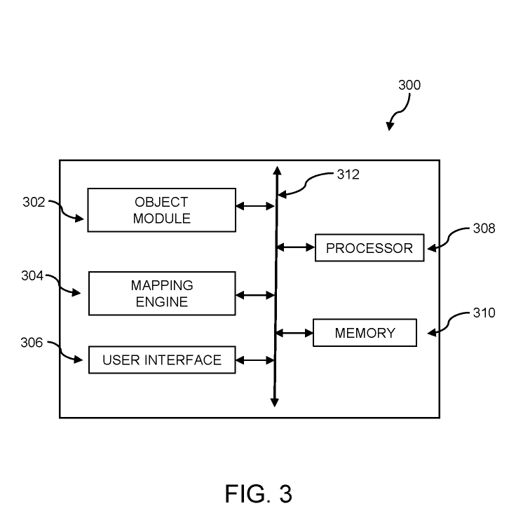

FIG. 3 illustrates a schematic diagram showing an implementation of an exemplary recall management system, in accordance with one or more example embodiments described herein. In one or more example embodiments, the recall management system 300 described herein facilitates management of one or more recall requests received at a facility (for instance, one or more facilities 102a, 102b,....102n as described in FIG. 1 of the current disclosure). In this regard, the recall management system 300 facilitates determination of mappings between enterprise objects (alternatively, referred to as first objects) submitted by users such as customers as a part of recall requests and template objects (alternatively, referred to as second objects) that are stored in repository/database to facilitate recall management. The recall management system 300 initially receives one or more recall requests from users such as customers, personnel associated with the facility, and/or the like. The one or more recall requests generally comprise the enterprise objects or the first objects from the users. Also, the recall management system 300 processes the one or more recall requests received at the facility. Based on this, the recall management system 300 also identifies first object(s) associated with a corresponding request of the one or more recall requests. For instance, when a user submits a recall request with one or more first objects, it is then received at the recall management system 300. The recall management system 300 then processes the received recall request to identify the one or more first objects in the request. Further, the recall management system 300 identifies at least some of the one or more first objects that needs to be parsed through a model. In this regard, the model corresponds to one or more large language models (LLMs). That is, at least some of the one or more first objects are processed by the LLMs in the recall management system 300 to determine a context associated with the one or more first objects. Then, the recall management system 300 retrieves one or more second objects from the database for further analysis. The one or more second objects correspond to the template objects already stored in the database or internally followed standard terminologies in the facility. Firstly, based on the parsing of the at least some first objects using the model such as LLMs, the recall management system 300 determines a first mapping for the one or more first objects with the one or more second objects. Secondly, the recall management system 300 uses one or more algorithms such as fuzzy name matching algorithm, algorithms for grammar-based synonym matching, data validation techniques, and/or the like along with one or more factors such as historical execution of recalls, a phase of recall process, a type of domain associated with recall request and/or the user, historical mappings, and/or the like. Using both of the first and second mappings, a mapping for each of the one or more first objects with the corresponding one or more second objects is identified by the recall management system 300. Also, the recall management system 300 renders via a user interface, the mapping for each of the one or more first objects using one or more visual representations. The one or more visual representations guide or facilitate a user to appropriately map the first objects with the second objects and/or understand the relationship between the first objects and the second objects.

In some example embodiments, the recall management system 300 is a server system (e.g., a server device) that facilitates a data analytics platform between one or more computing devices, one or more data sources, and/or one or more facilities. In some example embodiments, the recall management system 300 is a device with one or more processors and a memory. Also, in some example embodiments, the recall management system 300 is implementable via the cloud 106. The recall management system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the recall management system 300 comprises one or more components such as, an object module 302, a mapping engine 304, and/or a user interface 306. Additionally, in one or more example embodiments, the recall management system 300 comprises a processor 308 and/or a memory 310. In one or more example embodiments, one or more components of the recall management system 300 may be communicatively coupled to processor 308 and/or a memory 310 via a bus 312. In certain example embodiments, one or more aspects of the recall management system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the recall management system 300, a remote processor (e.g., a processor implemented on a server), and/or a virtual machine. In certain example embodiments, the processor 308 is in communication with the memory 310, the object module 302, the mapping engine 304, and/or the user interface 306 via the bus 312 to, for example, facilitate transmission of data between the processor 308, the memory 310, the object module 302, the mapping engine 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the recall management system 300 to carry out various functions in accordance with one or more embodiments disclosed herein. In accordance with some example embodiments described herein, the memory 310 may correspond to an internal or external memory of the recall management system 300. In some examples, the memory 310 may correspond to a database communicatively coupled to the recall management system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the object module 302 receives the one or more recall requests submitted by users associated with the facility. Provided that the one or more recall requests comprise the first objects, the object module 302 also receives the first objects upon the users submitting the one or more recall requests. For instance, when a user submits a recall request, the object module 302 receives one or more first objects (alternatively, one or more enterprise objects). At times, when the user is submitting the recall request, the user is expected to fill out forms as per operating procedures of the facility. Per this aspect, a form may comprise one or more fields where the user is expected to fill required details for placing the recall request. So, the user may fill appropriate details in the one or more fields of the form. The details filled in the one or more fields corresponds to the one or more first objects. For example, a customer may submit a recall request associated with packing of a product and this may include “classification” as an object i.e., enterprise object here. So, the customer may fill “classification” in one of a field of the recall request. Additionally, in one or more embodiments described herein, the object module 302 also processes the one or more recall requests received at the recall management system 300. In this regard, the object module 302 identifies the one or more first objects in the recall request.

Further, in one or more example embodiments, the object module 302 also stores the first objects. That is, the object module 302 stores the one or more objects received as a part of the recall request. This facilitates usage of the first objects for future reference as well. Also, in one or more example embodiments, the object module 302 stores the first objects in a structured manner or a classified manner. In this regard, the object module 302 classifies the first objects based on details of associated recall requests, phases of recall workflow, historical recall executions, domain associated with corresponding recall requests, user profile associated with corresponding recall requests, and/or the like. Per this aspect, storage of the first objects in the structured manner makes sure that required first objects are easily retrieved when necessary from the object module 302. In addition, in one or more example embodiments, the first objects stored in the object module 302 are updated regularly that is, at pre-defined time periods based on requirements of the facility and/or the users associated with the facility. In one or more example embodiments, the object module 302 also stores the template objects or the second objects related to the set of templates followed internally by the facility as well. In this regard, the object module 302 stores the template objects or the second objects in a structured manner or a classified manner similar to that of the first objects. Per this aspect, the object module 302 stores the second objects based on phases of recall workflow, historical recall executions, domain associated with corresponding recall requests, user profile associated with corresponding recall requests, and/or the like. Similar to the first objects, storage of the second objects in the structured manner makes sure that required second objects are easily retrieved when necessary from the object module 302. In addition, in one or more example embodiments, the second objects stored in the object module 302 are updated regularly that is, at pre-defined time periods based on requirements of the facility and/or the users associated with the facility. For example, in response to updating some templates of the set of templates, appropriate second objects may be updated as well in the object module 302.

In one or more example embodiments, the mapping engine 304 accesses the object module 302 to access relevant objects for further analysis and/or processing. For instance, upon receipt of the recall request along with the one or more first objects at the object module 302, the recall management system 300 makes sure to further process the recall request so that appropriate actions are undertaken in a timely manner. Initially, in this regard, the mapping engine 304 retrieves one or more second objects associated with the one or more fields of the recall request. That is, based on the one or more fields of the recall request, the mapping engine 304 identifies the one or more second objects that are relevant to the recall request and retrieves the same from the object module 302.

Then, in one or more example embodiments, the recall management system 300 via the mapping engine 304 parses at least one of the one or more first objects through a model. The model described herein corresponds to one or more large language models (LLMs). The one or more LLMs may be stored in the mapping engine 304 and/or the memory 310. Also, it is to be noted that the one or more LLMs are high fidelity LLMs specifically trained and/or built based on one or more requirements of the facility and/or the users associated with the facility. To parse the at least some of the one or more first objects, the mapping engine 304 selects the at least one of the one or more first objects. In some instances, the mapping engine 304 may randomly select the at least one of the one or more first objects. While in some instances, the mapping engine 304 may select the at least one of the one or more first objects based on input(s) received from the user via the user interface 306. Then, the mapping engine 304 applies the model that is, the one or more LLMs to the at least one of the one or more first objects. Further, the mapping engine 304 using the one or more LLMs identifies a type of the recall request based on the at least one of the one or more first objects. For example, if the one or more first objects comprise packaging, material, quality, batch, and/or the like, upon parsing at least one of the one or more first objects such as packaging and material, the mapping engine 304 determines that the recall request is associated with packaging of a product. In addition, in one or more example embodiments, the mapping engine 304 also determines a first mapping for the one or more first objects with the one or more second objects based on the parsing of the at least one first object. That is, the mapping engine 304 determines match between the one or more customer submitted objects or the enterprise objects and the one or more template objects retrieved from the object module 302. In this regard, the parsing of the at least one first object facilitates the mapping engine 304 to identify a first match associated with the one or more first objects. That is, for instance, based on the type of the recall request, the mapping engine 304 identifies the first match. The aforementioned first match corresponds to at least one of a synonym match and a semantic match of the one or more first objects with the one or more second objects. For example, if the one or more first objects comprise packaging, material, quality, batch, and/or the like in the recall request, then the mapping engine 304 based on the parsing of the at least one of the one or more first objects such as packaging and material identifies that the recall request is associated with packaging of a product. Using this information, the mapping engine 304 identifies a synonym match and/or a semantic match of the one or more first objects with the one or more second objects. This is to make sure that the first objects in the recall request for packaging are mapped with appropriate second objects in templates related to addressing packaging recall requests. Using the synonym match and/or the semantic match by the one or more LLMs, the mapping engine 304 determines at least one second object that matches each of the one or more first objects. That is, the mapping engine 304 based on the synonym match and/or the semantic match determines one or more top second objects that match each of the one or more first objects. For example, for a first object packaging, the mapping engine 304 using the one or more LLMs performs the synonym match and/or the semantic match with the one or more second objects. Based on the synonym match and/or the semantic match, the mapping engine 304 determines that packaging and quality standard are top two second objects that match the first object packaging.

Further, in one or more example embodiments, the mapping engine 304 determines a second mapping for the one or more first objects with the one or more second objects. In this regard, the second mapping is based at least on one or more algorithms and one or more factors. The one or more algorithms may be, but not limited to fuzzy name matching algorithm, algorithms for grammar-based synonym matching, data validation techniques, and/or the like. Whereas the one or more factors may be, but not limited to historical execution of recalls, a phase of recall process, a type of domain associated with recall request and/or the user, historical mappings, and/or the like. Using such algorithms and factors, the mapping engine 304 identifies a second match of the one or more first objects with the one or more second objects. The aforementioned second match corresponds to at least one of a fuzzy name match, a workflow-based match, a grammar-based synonym match, one or more historical matches, and one or more historical workflow-based matches of the one or more first objects with the one or more second objects. In one example, when a first object is “pkging”, the mapping engine 304 uses fuzzy name matching algorithm to match “pkging” with a corresponding second object. In this regard, the mapping engine 304 identifies that “pkging” actually corresponds to a second object “packaging” based on fuzzy name match. So, the first object “pkging” is identified to map on to the second object “packaging”. In another example, the mapping engine 304 detects a phase/workflow of recall process. In this regard, the mapping engine 304 also provides one or more static tags to the one or more first objects and/or the one or more second objects. The static tags indicate a probability or a relevance of the one or more first objects and/or the one or more second objects to the detected phase/workflow. The mapping engine 304 during the second mapping filters out some of the one or more first objects and/or some of the one or more second objects if they are irrelevant to the phase/workflow of recall process. That is, if some of the one or more first objects and/or some of the one or more second objects have low probability, then such objects are filtered out. Yet in another example, if the one or more first objects are also present in one or more historical recall requests, then the mapping engine 304 reuses matches associated with the one or more historical recall requests to perform the second mapping. Further, in another example, based on a detection of phase/workflow of recall process, the mapping engine 304 also refers to one or more historical recall executions for the same phase/workflow of recall process to perform the second mapping. Furthermore, in another example, based on a user associated with recall request, the mapping engine 304 checks historical recall requests for the same user to perform second mapping as well. Accordingly, the mapping engine 304 makes sure to use all possible algorithms and factors such that the first objects are appropriately mapped onto the second objects. The mapping engine 304 based on the second match determines at least one second object that matches each of the one or more first objects. That is, the mapping engine 304 based on the fuzzy name match, the workflow-based match, the grammar-based synonym match, the one or more historical matches, and/or the one or more historical workflow-based matches determines one or more top second objects that match each of the one or more first objects.

In one or more example embodiments, the mapping engine 304 identifies a mapping for each of the one or more first objects with the corresponding one or more second objects based on the first mapping and the second mapping. That is, using both of the first mapping and the second mapping, the mapping engine 304 identifies a final mapping for each of the one or more first objects with the corresponding one or more second objects. In this regard, the mapping engine 304 assigns a first weighted score to the first mapping. This score is assigned to the first mapping based on how well the first objects map onto corresponding second objects based on the first match. Also, the mapping engine 304 assigns a second weighted score to the second mapping similar to that of the first mapping. Similarly, this score is assigned to the second mapping based on how well the first objects map onto corresponding second objects based on the second match. Using both of the first weighted score and the second weighted score, the mapping engine 304 identifies the mapping for each of the one or more first objects with the corresponding one or more second objects. With such an approach, the mapping engine 304 makes sure that the first objects are best matched to correct and most relevant second objects. Then, in one or more example embodiments, the mapping engine 304 via the user interface 306 also renders the mapping for each of the one or more first objects using one or more visual representations. In this regard, the mapping engine 304 also determines the one or more visual representations based on the mapping for each of the one or more first objects. That is, based on the identified mappings and/or the user accessing the mappings, the mapping engine 304 determines which of the one or more visual representations should be used to render the mapping on the user interface 306. The one or more visual representations correspond to visually highlighting a first object and a corresponding second object to which the first object is to be mapped, showing a link between the first object and the corresponding second object, highlighting the first object and one or more top second objects that map onto the first object with a color, and/or the like. In some instances, the mapping engine 304 automatically performs the mapping for each of the one or more first objects with the corresponding one or more second objects and renders the mapping using the one or more visual representations. While in some instances, the mapping engine 304 identifies the mapping and renders the mapping using the one or more visual representations so that the user can perform the mapping. For example, the one or more visual representations may act as a guide to the user to perform the mapping by drag and drop approach, selecting objects in a drop-down menu, and/or the like. Also, in one or more example embodiments, the mapping engine 304 creates one or more tasks based on the identified mapping. In this regard, the one or more tasks correspond to further steps that is to be taken by one or more focal in the facility to address the recall request. Using the mappings, the mapping engine 304 identifies an appropriate focal to whom the recall request is to be directed so that relevant actions can be taken in the facility. Additionally, in one or more example embodiments, the recall management system 300 also makes sure to store the mappings for future references. With this, the recall requests submitted to the facility can be efficiently processed. This also saves time and computing resources along with increased productivity of resources and recall processes in the facility.

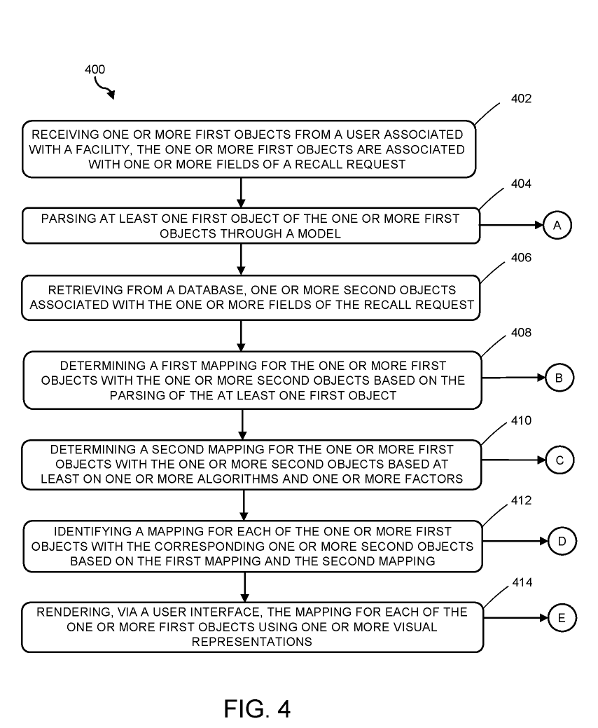

FIG. 4 illustrates a flowchart showing a method described in accordance with one or more example embodiments described herein. In this regard, FIG. 4 illustrates operations that may be performed by the recall management system 300. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400. At step 402 of the exemplary flowchart 400, the recall management system 300 comprises means such as, the object module 302 to receive one or more first objects from a user associated with a facility (for instance, one or more facilities 102a, 102b,....102n as described in FIG. 1 of the current disclosure) where one or more recall requests need to be managed. In this regard, the one or more first objects are associated with one or more fields of a recall request. At step 404 of the exemplary flowchart 400, the recall management system 300 comprises means such as, the mapping engine 304 to parse at least one first object of the one or more first objects through a model. At step 406 of the exemplary flowchart 400, the recall management system 300 comprises means such as, the mapping engine 304 to retrieve from a database, one or more second objects associated with the one or more fields of the recall request. At step 408 of the exemplary flowchart 400, the recall management system 300 comprises means such as, the mapping engine 304 to determine a first mapping for the one or more first objects with the one or more second objects based on the parsing of the at least one first object. At step 410 of the exemplary flowchart 400, the recall management system 300 comprises means such as, the mapping engine 304 to determine a second mapping for the one or more first objects with the one or more second objects based at least on one or more algorithms and one or more factors. At step 412 of the exemplary flowchart 400, the recall management system 300 comprises means such as, the mapping engine 304 to identify a mapping for each of the one or more first objects with the corresponding one or more second objects based on the first mapping and the second mapping. At step 414 of the exemplary flowchart 400, the recall management system 300 comprises means such as, the user interface 306 to render the mapping for each of the one or more first objects using one or more visual representations.

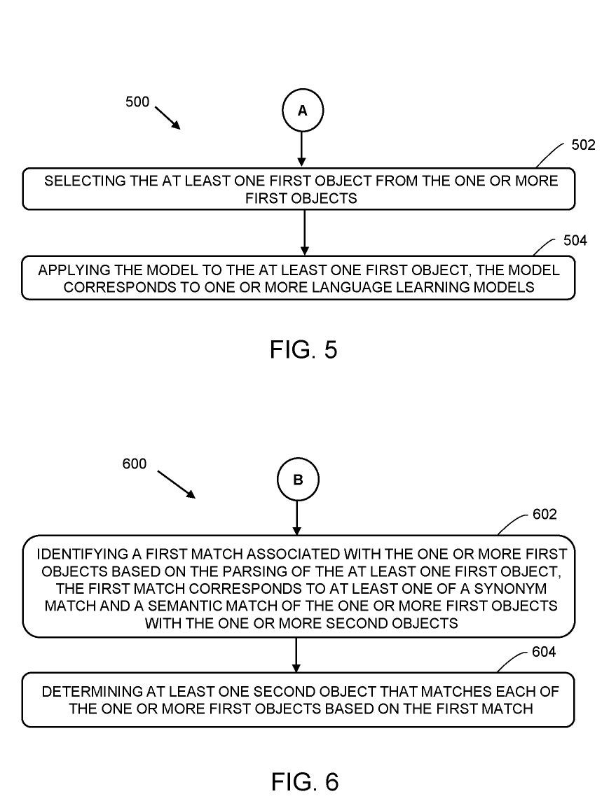

FIG. 5 illustrates a flowchart showing a method described in accordance with one or more example embodiments described herein. In this regard, FIG. 5 illustrates operations that may be performed by the recall management system 300. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500. At step 502 of the exemplary flowchart 500, the recall management system 300 comprises means such as, the mapping engine 304 to select the at least one first object from the one or more first objects. At step 504 of the exemplary flowchart 500, the recall management system 300 comprises means such as, the mapping engine 304 to apply the model to the at least one first object. In this regard, the model corresponds to one or more language learning models.

FIG. 6 illustrates a flowchart showing a method described in accordance with one or more example embodiments described herein. In this regard, FIG. 6 illustrates operations that may be performed by the recall management system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the recall management system 300 comprises means such as, the mapping engine 304 to identify a first match associated with the one or more first objects based on the parsing of the at least one first object. In this regard, the first match corresponds to at least one of a synonym match and a semantic match of the one or more first objects with the one or more second objects. At step 604 of the exemplary flowchart 600, the recall management system 300 comprises means such as, the mapping engine 304 to determine at least one second object that matches each of the one or more first objects based on the first match.

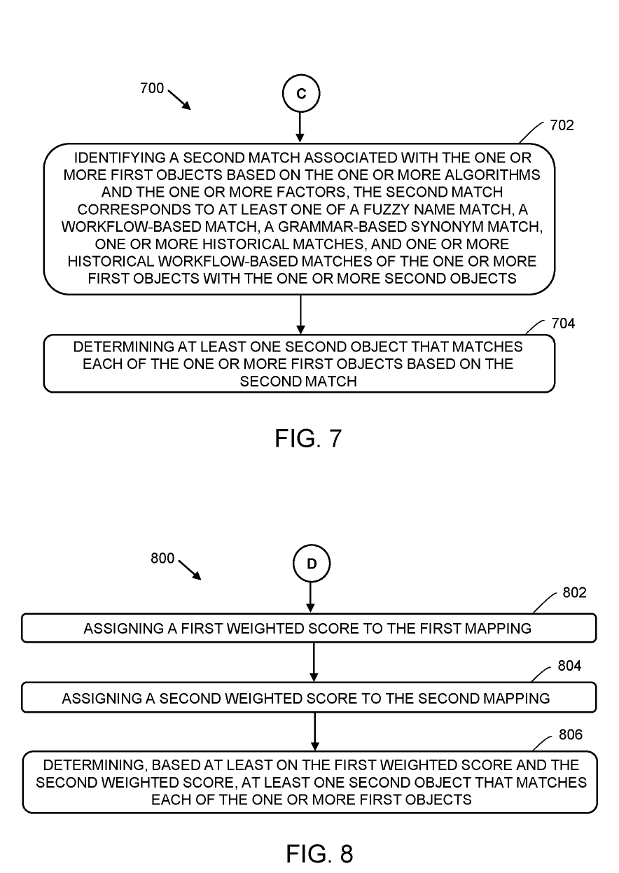

FIG. 7 illustrates a flowchart showing a method described in accordance with one or more example embodiments described herein. In this regard, FIG. 7 illustrates operations that may be performed by the recall management system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the recall management system 300 comprises means such as, the mapping engine 304 to identify a second match associated with the one or more first objects based on the one or more algorithms and the one or more factors. In this regard, the second match corresponds to at least one of a fuzzy name match, a workflow-based match, a grammar-based synonym match, one or more historical matches, and one or more historical workflow-based matches of the one or more first objects with the one or more second objects. At step 704 of the exemplary flowchart 700, the recall management system 300 comprises means such as, the mapping engine 304 to determine at least one second object that matches each of the one or more first objects based on the second match.

FIG. 8 illustrates a flowchart showing a method described in accordance with one or more example embodiments described herein. In this regard, FIG. 8 illustrates operations that may be performed by the recall management system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the recall management system 300 comprises means such as, the mapping engine 304 to assign a first weighted score to the first mapping. At step 804 of the exemplary flowchart 800, the recall management system 300 comprises means such as, the mapping engine 304 to assign a second weighted score to the second mapping. Then, at step 806 of the exemplary flowchart 800, the recall management system 300 comprises means such as, the mapping engine 304 to determine based at least on the first weighted score and the second weighted score, at least one second object that matches each of the one or more first objects.

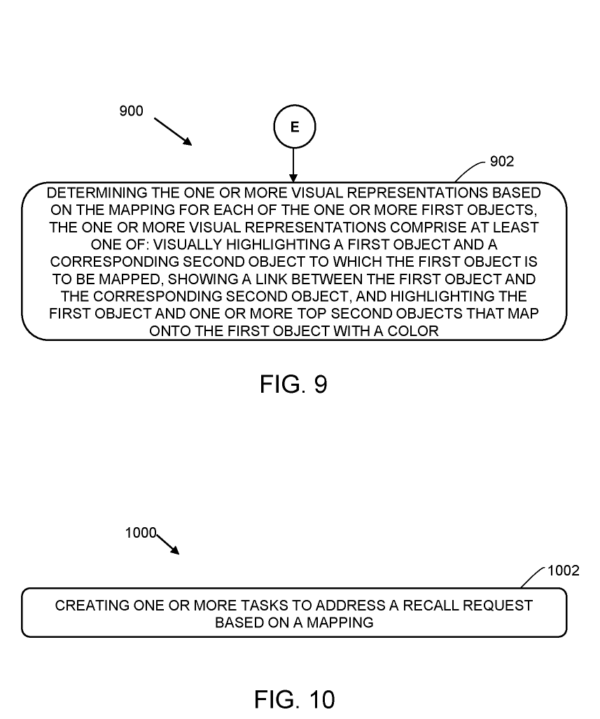

FIG. 9 illustrates a flowchart showing a method described in accordance with one or more example embodiments described herein. In this regard, FIG. 9 illustrates operations that may be performed by the recall management system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the recall management system 300 comprises means such as, the mapping engine 304 to determine the one or more visual representations based on the mapping for each of the one or more first objects. In this regard, the one or more visual representations comprise at least one of: visually highlighting a first object and a corresponding second object to which the first object is to be mapped, showing a link between the first object and the corresponding second object, and highlighting the first object and one or more top second objects that map onto the first object with a color.

FIG. 10 illustrates a flowchart showing a method described in accordance with one or more example embodiments described herein. In this regard, FIG. 10 illustrates operations that may be performed by the recall management system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the recall management system 300 comprises means such as, the mapping engine 304 to create one or more tasks to address a recall request based on a mapping identified by the mapping engine 304.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as "thereafter," "then," "next," etc. are not intended to limit the order of the steps; these words are simply used to guide the reader through the description of the methods. Further, any reference to claim elements in the singular, for example, using the articles "a," "an" or "the" is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method for managing one or more recall requests in a facility, the method comprising:
receiving one or more first objects from a user associated with the facility, wherein the one or more first objects are associated with one or more fields of a recall request;
parsing at least one first object of the one or more first objects through a model;
retrieving from a database, one or more second objects associated with the one or more fields of the recall request;
determining a first mapping for the one or more first objects with the one or more second objects based on the parsing of the at least one first object;
determining a second mapping for the one or more first objects with the one or more second objects based at least on one or more algorithms and one or more factors;
identifying a mapping for each of the one or more first objects with the corresponding one or more second objects based on the first mapping and the second mapping; and
rendering, via a user interface, the mapping for each of the one or more first objects using one or more visual representations.

2. The method of claim 1, wherein parsing the at least one first object through the model comprises:
selecting the at least one first object from the one or more first objects; and
applying the model to the at least one first object, wherein the model corresponds to one or more language learning models.

3. The method of claim 1, wherein determining the first mapping for the one or more first objects with the one or more second objects comprises:
identifying a first match associated with the one or more first objects based on the parsing of the at least one first object, wherein the first match corresponds to at least one of a synonym match and a semantic match of the one or more first objects with the one or more second objects; and
determining at least one second object that matches each of the one or more first objects based on the first match.

4. The method of claim 1, wherein determining the second mapping for the one or more first objects with the one or more second objects comprises:
identifying a second match associated with the one or more first objects based on the one or more algorithms and the one or more factors, wherein the second match corresponds to at least one of a fuzzy name match, a workflow-based match, a grammar-based synonym match, one or more historical matches, and one or more historical workflow-based matches of the one or more first objects with the one or more second objects; and
determining at least one second object that matches each of the one or more first objects based on the second match.

5. The method of claim 1, wherein identifying the mapping for each of the one or more first objects with the corresponding one or more second objects comprises:
assigning a first weighted score to the first mapping;
assigning a second weighted score to the second mapping; and
determining, based at least on the first weighted score and the second weighted score, at least one second object that matches each of the one or more first objects.

6. The method of claim 1, wherein rendering the mapping for each of the one or more first objects comprises:
determining the one or more visual representations based on the mapping for each of the one or more first objects, wherein the one or more visual representations comprise at least one of: visually highlighting a first object and a corresponding second object to which the first object is to be mapped, showing a link between the first object and the corresponding second object, and highlighting the first object and one or more top second objects that map onto the first object with a color.

7. The method of claim 1, further comprising:
creating one or more tasks to address the recall request based on the mapping.

8. A system for managing one or more recall requests in a facility, the system comprising:
a processor;
a memory communicatively coupled to the processor, wherein the memory comprises one or more instructions which when executed by the processor, cause the processor to:
receive one or more first objects from a user associated with the facility, wherein the one or more first objects are associated with one or more fields of a recall request;
parse at least one first object of the one or more first objects through a model;
retrieve from a database, one or more second objects associated with the one or more fields of the recall request;
determine a first mapping for the one or more first objects with the one or more second objects based on the parsing of the at least one first object;
determine a second mapping for the one or more first objects with the one or more second objects based at least on one or more algorithms and one or more factors;
identify a mapping for each of the one or more first objects with the corresponding one or more second objects based on the first mapping and the second mapping; and
render, via a user interface, the mapping for each of the one or more first objects using one or more visual representations.

9. The system of claim 8, wherein the processor is further configured to:
select the at least one first object from the one or more first objects; and
apply the model to the at least one first object, wherein the model corresponds to one or more language learning models.

10. The system of claim 8, wherein the processor is further configured to:
identify a first match associated with the one or more first objects based on the parsing of the at least one first object, wherein the first match corresponds to at least one of a synonym match and a semantic match of the one or more first objects with the one or more second objects; and
determine at least one second object that matches each of the one or more first objects based on the first match.

11. The system of claim 8, wherein the processor is further configured to:
identify a second match associated with the one or more first objects based on the one or more algorithms and the one or more factors, wherein the second match corresponds to at least one of a fuzzy name match, a workflow-based match, a grammar-based synonym match, one or more historical matches, and one or more historical workflow-based matches of the one or more first objects with the one or more second objects; and
determine at least one second object that matches each of the one or more first objects based on the second match.

12. The system of claim 8, wherein the processor is further configured to:
assign a first weighted score to the first mapping;
assign a second weighted score to the second mapping; and
determine, based at least on the first weighted score and the second weighted score, at least one second object that matches each of the one or more first objects.

13. The system of claim 8, wherein the processor is further configured to:
determine the one or more visual representations based on the mapping for each of the one or more first objects, wherein the one or more visual representations comprise at least one of: visually highlighting a first object and a corresponding second object to which the first object is to be mapped, showing a link between the first object and the corresponding second object, and highlighting the first object and one or more top second objects that map onto the first object with a color.

14. The system of claim 8, wherein the processor is further configured to:
create one or more tasks to address the recall request based on the mapping.

15. A non-transitory, computer-readable storage medium having stored thereon executable instructions that, when executed by one or more processors, cause the one or more processors to:
receive one or more first objects from a user associated with the facility, wherein the one or more first objects are associated with one or more fields of a recall request;
parse at least one first object of the one or more first objects through a model;
retrieve from a database, one or more second objects associated with the one or more fields of the recall request;
determine a first mapping for the one or more first objects with the one or more second objects based on the parsing of the at least one first object;
determine a second mapping for the one or more first objects with the one or more second objects based at least on one or more algorithms and one or more factors;
identify a mapping for each of the one or more first objects with the corresponding one or more second objects based on the first mapping and the second mapping; and
render, via a user interface, the mapping for each of the one or more first objects using one or more visual representations.

16. The non-transitory, computer-readable storage medium of claim 15, wherein the one or more processors is further configured to:
select the at least one first object from the one or more first objects; and
apply the model to the at least one first object, wherein the model corresponds to one or more language learning models.

17. The non-transitory, computer-readable storage medium of claim 15, wherein the one or more processors is further configured to:
identify a first match associated with the one or more first objects based on the parsing of the at least one first object, wherein the first match corresponds to at least one of a synonym match and a semantic match of the one or more first objects with the one or more second objects; and
determine at least one second object that matches each of the one or more first objects based on the first match.

18. The non-transitory, computer-readable storage medium of claim 15, wherein the one or more processors is further configured to:
identify a second match associated with the one or more first objects based on the one or more algorithms and the one or more factors, wherein the second match corresponds to at least one of a fuzzy name match, a workflow-based match, a grammar-based synonym match, one or more historical matches, and one or more historical workflow-based matches of the one or more first objects with the one or more second objects; and
determine at least one second object that matches each of the one or more first objects based on the second match.

19. The non-transitory, computer-readable storage medium of claim 15, wherein the one or more processors is further configured to:
assign a first weighted score to the first mapping;
assign a second weighted score to the second mapping; and
determine, based at least on the first weighted score and the second weighted score, at least one second object that matches each of the one or more first objects.

20. The non-transitory, computer-readable storage medium of claim 15, wherein the one or more processors is further configured to:
determine the one or more visual representations based on the mapping for each of the one or more first objects, wherein the one or more visual representations comprise at least one of: visually highlighting a first object and a corresponding second object to which the first object is to be mapped, showing a link between the first object and the corresponding second object, and highlighting the first object and one or more top second objects that map onto the first object with a color.
